(19) United States
(12) Patent Application Publication
(10) Pub. No.: US 2009/0279781 A1
(43) Pub. Date: Nov. 12, 2009

(54) IMAGE PROCESSING APPARATUS, IMAGE PROCESSING METHOD, AND STORAGE MEDIUM

(75) Inventor: Hironobu Kitabatake, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/436,002

(22) Filed: May 5, 2009

(30) Foreign Application Priority Data
May 7, 2008 (JP) 2008-120977

(51) Int. Cl. G06K 9/34; G06K 9/46

(52) U.S. Cl. 382/176; 382/190

(57) ABSTRACT

An image processing apparatus selects one extraction method among a plurality of extraction methods and then extracts feature information of objected image data, from the objected image data using the selected extraction method. The extracted feature information is registered, and the objected image data is output together with identification information indicating the extraction method that was used in the extraction.

### BACKGROUND OF THE INVENTION

1. Field of the Invention

The present invention relates to an image processing apparatus configured to extract and register feature information that includes a feature of image data, an image processing method, and a storage medium.

2. Description of the Related Art

With the widespread use of office automation (OA) apparatuses such as personal computers, more documents are generated by applications on personal computers in offices. Since documents that are printed on recording media including paper can be scanned by an apparatus such as a scanner and converted into electronic image data, the content of the documents can be easily passed on to another apparatus.

Under these circumstances where computerized documents are handled on a daily basis, many document management systems that compile and manage generated documents in a database have been proposed. Such document management systems can store documents, and can search for the documents using feature information that has preliminarily been extracted based on image data corresponding to the documents.

However, in such a document management system, the feature information needs to be extracted using different extraction methods depending on an attribute of an object included in the image data when the feature information is extracted from the image data.

Japanese Patent Application Laid-Open No. 2004-334334 discusses a method in which text feature information and image feature information are stored in a memory when a document is registered. The text feature information is extracted based on a text included in the document while the image feature information is extracted based on an image included in the document. When a user searches for a document, character recognition processing is performed with respect to the image data of the document to be searched, and based on the obtained text, text feature information is acquired. Image feature information of the document to be searched is also acquired. Then, the document is searched according to the acquired feature information.

However, according to the document management system discussed in Japanese Patent Application Laid-Open No. 2004-334334, each time the document is stored in the database for management, two types of feature information including the text feature information and the image feature information, need to be extracted. Accordingly, the extraction processing of the feature information takes time. Further, the document management system itself will be heavily loaded. Additionally, since it may be necessary to register a plurality of feature information when registering a document in a database, increased memory capacity may be necessary for storing the feature information.

Instead of extracting a plurality of feature information of one document using a plurality of extraction methods, feature information can be extracted by using a certain extraction method selected from the plurality of extraction methods.

However, when a document is searched, if an extraction method different from the method that has been used at the time of document registration is used in extracting the feature information, then feature information with a different value may be extracted from the same document. Thus, a document cannot be searched appropriately. To avoid this, when a user registers a document, the user needs to memorize the extraction method that has been used. Further, if the user searches for a document which has been registered by another person, the user will not be able to know which extraction method has been used at the time of document registration. Thus, in order to find a desired document, feature information needs to be extracted by using a plurality of extraction methods.

### SUMMARY OF THE INVENTION

The present invention is directed to a method for extracting feature information from objected image data, and outputting the objected image data together with identification information that indicates an extraction method used in extracting the feature information.

According to an aspect of the present invention, an image processing apparatus includes a storage unit configured to store objected image data, a first selection unit configured to select any one extraction method among a plurality of extraction methods, an extraction unit configured to extract feature information indicating a feature of the objected image data using the extraction method selected by the first selection unit, from the objected image data, a registration unit configured to register feature information extracted by the extraction unit, and an output unit configured to output the objected image data with identification information indicating the extraction method selected by the first selection unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of an image processing apparatus applicable to a document search system according to an exemplary embodiment of the present invention.

FIG. 2 is a plan view illustrating a configuration of an operation panel unit illustrated in FIG. 1.

FIG. 3 is a plan view illustrating a configuration of an operation panel unit illustrated in FIG. 1.

FIG. 4 is a flowchart illustrating an example of a first data processing procedure of the image processing apparatus according to a first exemplary embodiment of the present invention.

FIG. 5 is a flowchart illustrating an example of a second data processing procedure of the image processing apparatus according to the first exemplary embodiment of the present invention.

FIG. 6 is a flowchart illustrating an example of a third data processing procedure of the image processing apparatus according to the first exemplary embodiment of the present invention.

FIG. 7 illustrates an example of user interface (UI) displayed on a display device of the information processing apparatus according to an exemplary embodiment of the present invention.

FIG. 8 is a flowchart illustrating an example of a fourth data processing procedure of the image processing apparatus according to the first exemplary embodiment of the present invention.

FIG. 9 illustrates an example of a document management table illustrated in FIG. 1.

FIG. 10 illustrates an example of a document registered in an external memory illustrated in FIG. 1.

FIG. 11 is a flowchart illustrating an example of a fifth data processing procedure of the image processing apparatus according to the first exemplary embodiment of the present invention.

FIG. 12 is a flowchart illustrating an example of a sixth data processing procedure of the image processing apparatus according to a second exemplary embodiment of the present invention.

FIG. 13 illustrates an example of user interface displayed on a touch panel illustrated in FIG. 2.

FIG. 14 is a flowchart illustrating an example of a seventh data processing procedure of the image processing apparatus according to the second exemplary embodiment of the present invention.

FIG. 15 is a flowchart illustrating an example of an eighth data processing procedure of the image processing apparatus according to the second exemplary embodiment of the present invention.

FIG. 16 is a block diagram illustrating a configuration of the image processing apparatus applicable to the document search system according to a third exemplary embodiment of the present invention.

FIG. 17 is a block diagram illustrating a configuration of a server applicable to the document search system according to the third exemplary embodiment of the present invention.

FIG. 18 is a flowchart illustrating an example of a ninth data processing procedure of the image processing apparatus according to the third exemplary embodiment of the present invention.

FIG. 19 is a flowchart illustrating an example of a tenth data processing procedure of the image processing apparatus according to the third exemplary embodiment of the present invention.

FIG. 20 is a flowchart illustrating an example of an eleventh data processing procedure of the image processing apparatus according to an exemplary embodiment of the present invention.

FIG. 21 is a memory map of a storage medium configured to store various types of data processing programs which can be read out by the image processing apparatus according to the third exemplary embodiment of the present invention.

### DETAILED DESCRIPTION OF THE EMBODIMENTS

Various exemplary embodiments, features, and aspects of the invention will be described in detail below with reference to the drawings.

A configuration of a digital multifunction peripheral will be described as an example of an image processing apparatus in a document search system according to a first exemplary embodiment of the present invention.

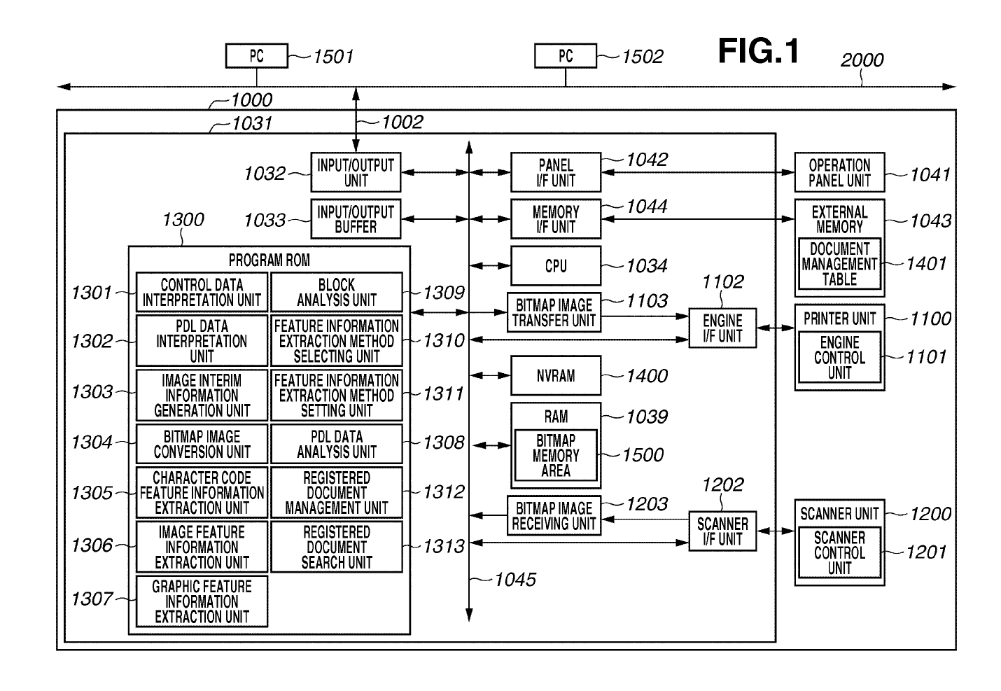

FIG. 1 is a block diagram illustrating a configuration of an image processing apparatus in a document search system according to the present exemplary embodiment. In FIG. 1, the image processing apparatus is a multifunction peripheral (MFP) including a scanner unit and a printer unit. The scanner unit and the printer unit may not be included in the image processing apparatus if they are communicatably connected to the image processing apparatus. According to the present exemplary embodiment, the image processing apparatus communicates with an information processing apparatus via a network, however, the present invention is also applicable to a document search system in which an image processing apparatus and an information processing apparatus communicate with each other via a local interface that allows bidirectional communication.

In FIG. 1, a MFP 1000 includes three main portions, a control unit 1031 configured to control operation of the whole apparatus, a printer unit 1100 configured to perform printing of an image onto a recording medium, and a scanner unit 1200 configured to scan an image into the apparatus by scanning an image included in a document and generating its image data.

The printer unit 1100 includes an engine control unit 1101. The scanner unit 1200 includes a scanner control unit 1201. The scanner unit 1200 scans and reads an image included in a document by receiving reflected light using an image sensor such as a charge-coupled device (CCD). The document can be a color or a monochromatic document. A plurality of objects having different attributes can be included in the image of the document. The attributes are, for example, an image, a character, and a graphic.

An input/output unit 1032 is used for transmitting data to a client terminal (a personal computer (PC) 1501, a PC 1502) or a server terminal on a network 2000 via a communication line 1002 connected to the network 2000.

An input/output buffer 1033 is used for transmitting and receiving various data including a control code for printing and various PDL (Page Description Language) data sent via the network 2000, or various data in the apparatus.

A central processing unit (CPU) 1034 controls the overall operation of the control unit 1031. A program read-only memory (ROM) 1300 is configured to store a program executed by the CPU 1034. Details of each module in the program ROM 1300 will be described below.

A random access memory (RAM) 1039 is used as a work memory for interpretation of data and the above-described control code, calculation necessary in a printing operation performed by the printer unit 1100, an image scanning operation performed by the scanner unit 1200, or processing of image data which is input/output.

A non-volatile RAM (NVRAM) 1400 is used for storing data including various settings that need to be held even when the apparatus is shut down. A bitmap memory area 1500, in which the supplied bitmap image is stored, is included in the RAM 1039.

An external memory 1043 is used for storing data such as print data or image data sent from an outside device, or storing information about the printing apparatus. The external memory 1043 is connected to the control unit 1031 via a memory I/F unit 1044.

Each module in the program ROM 1300 plays different roles as described below. A control data interpretation unit 1301 interprets printing control data sent from a host computer. A PDL data interpretation unit 1302 interprets PDL data. An image interim information generation unit 1303 generates various types of image objects, each of which is subsequently converted into a bitmap image.

A bitmap image conversion unit 1304 converts an image object into a bitmap image. A character code feature information extraction unit 1305 recognizes a character code of a text area of the objected image data or the image data to be searched from a result of analysis obtained from a block analysis unit 1309 or a PDL data analysis unit 1308, and then extracts character code feature information.

An image feature information extraction unit 1306 extracts a color histogram from an image area of the objected image data or the image data to be searched, and then extracts image feature information. A graphic feature information extraction unit 1307 extracts vector information of a graphic from a graphic area of the objected image data or the image data to be searched, and then extracts graphic feature information.

The PDL data analysis unit 1308 determines whether the attribute of the object included in the image data, is text, image, or graphic, before it registers the image data in PDL format. The block analysis unit 1309 determines and analyzes text, image, or graphic included in a document from a bitmap image generated by the scanner unit 1200.

A feature information extraction method selection unit 1310 selects one among three feature information extraction methods. More particularly, the feature information extraction method selection unit 1310 selects one extraction unit among the character code feature information extraction unit 1305, the image feature information extraction unit 1306, and the graphic feature information extraction unit 1307.

A registered document management unit 1312 manages a document registered in a document management table 1401 stored in the external memory 1043. A registered document search unit 1313 is used for searching for a predetermined document from the documents registered in the document management table 1401. Feature information extracted from the image data, which is feature information about the feature of the image data, is registered in the document management table 1401 together with the image data corresponding to the registered document.

A feature information extraction method setting unit 1311 selects an extraction method for extracting feature information used for searching for a document, from a plurality of feature information extraction methods, and then sets the selected extraction method as a method for searching for a registered document.

A bitmap image transfer unit 1103 transfers the bitmap image converted by the bitmap image conversion unit 1304 and the bitmap image generated by the scanner unit 1200 to the printer unit 1100 via an engine I/F unit 1102.

A scanner I/F unit 1202 connects the scanner unit 1200 to the control unit 1031. A bitmap image receiving unit 1203 receives the bitmap image generated by the scanner unit 1200.

An operation panel unit 1041 is used for inputting information that restricts commands depending on each user, operating the apparatus, or displaying error message or operation guide via a user interface. The operation panel unit 1041 is connected to the control unit 1031 via a panel I/F unit 1042 and a system bus 1045. The above-described devices and the CPU 1034 are connected via the system bus 1045.

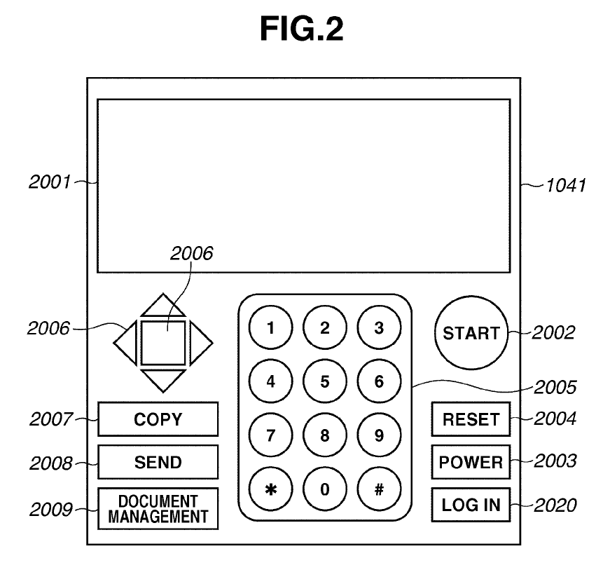

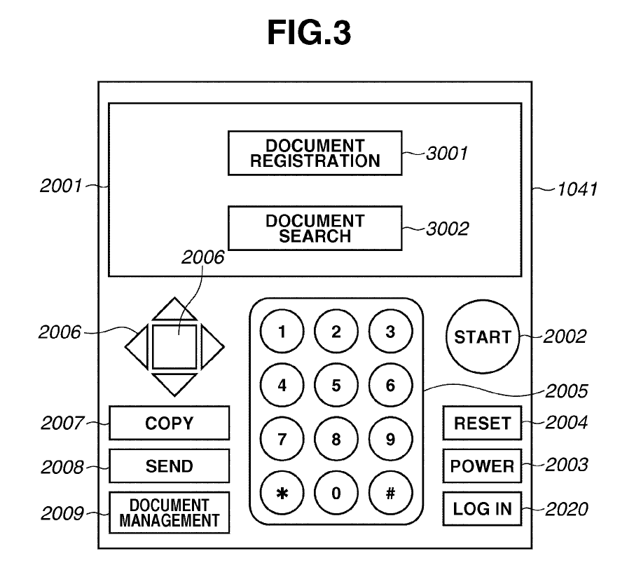

FIGS. 2 and 3 are views illustrating a configuration of the operation panel unit 1041 illustrated in FIG. 1. In FIGS. 2 and 3, the operation panel unit 1041 includes a liquid crystal panel 2001 that displays various information about the MFP 1000 such as a registered image or print status.

The liquid crystal panel 2001 is a touch panel. When the user touches the liquid crystal panel 2001, the touch is detected and character information can be input via the screen. According to a second exemplary embodiment described below, the user can select feature information extraction method that is used in registering the image data with feature information extraction method that is used in searching image data by operating the liquid crystal panel 2001.

The operation panel unit 1041 includes a start key 2002 used for starting, for example, copy operation, a reset key 2004 used for resetting the apparatus, and a power switch 2003 used for turning on/off the power. The operation panel unit 1041 includes a numeric keypad 2005 used for specifying a number of copies to be made, a cursor key used for moving a cursor displayed on the liquid crystal panel 2001, and a determination key 2006 used for selecting a function displayed on the liquid crystal panel 2001. Additionally, the operation panel unit 1041 includes a copy key 2007, a send key 2008, and a document management button 2009, from which, when a function of the MFP is used, a key corresponding to the function is selected.

A log-in key 2020 is used for identifying the user and for verification.

If the document management button 2009 illustrated in FIG. 2 is pressed, a document registration button 3001 and a document search button 3002 illustrated in FIG. 3 will be displayed on the operation panel unit 1041.

The document registration function is used, when registering image data corresponding to a document, for executing a first selection processing, which is processing for selecting one feature information extraction method among a plurality of feature information extraction methods, extracting feature information of the image data using the selected feature information extraction method, and registering the image data together with the extracted feature information.

Processing of registering image data generated by a scanner 1200 will now be described. The scanner 1200 scans an image included in a document and generates image data.

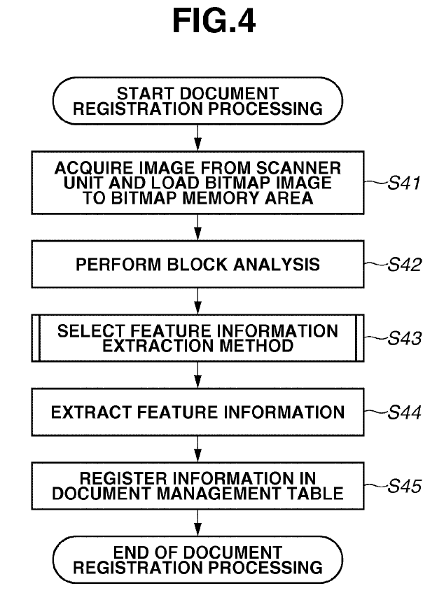

FIG. 4 is a flowchart illustrating an example of a first data processing procedure of the image processing apparatus according to the present exemplary embodiment. In FIG. 4, document registration processing is taken as an example of the first data processing. Each of steps S41-S45 is realized by the CPU 1034, which reads out a control program stored in the ROM 1300, loads it to the RAM 1039, and executes it. The CPU 1034 can refer to the document management table 1401 stored in the external memory 1043 when the CPU 1034 executes the control program.

When the user presses the document management button 2009 illustrated in FIG. 2, the display screen is changed to the screen illustrated in FIG. 3, and the document registration key 3001 and a document search key 3002 are displayed on the touch panel. If the document registration button 3001 is pressed, the document registration processing is started.

In step S41, if the user presses the start key 2002 on the touch panel of the operation panel unit 1041, the CPU 1034 acquires image information from the scanner unit 1200 via the scanner I/F unit 1202 and the bitmap image receiving unit 1203. The CPU 1034 supplies the acquired image information to the bitmap memory area 1500 in the RAM 1039.

In step S42, the CPU 1034 performs block analysis. By using a publicly-known segmentation method, the CPU 1034 segments the image data into areas having similar features, and extracts three types of areas (objects) each having a different attribute. The attributes are character, image, and graphic.

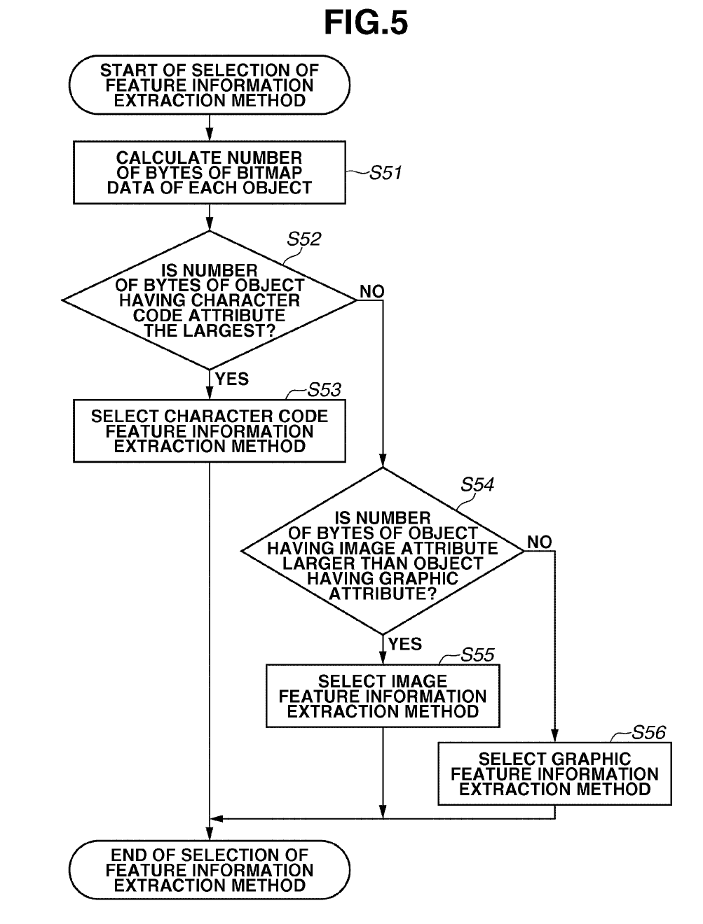

In step S43, the CPU 1034 selects one extraction method among the three feature information extraction methods, i.e., the character code feature information extraction method, the image feature information extraction method, and the graphic feature information extraction method. Processing flow for selecting the feature information extraction method is illustrated in FIG. 5. The character code feature information extraction method is an extraction method for the character code feature information extraction unit 1305 illustrated in FIG. 1. Similarly, the image feature information extraction method is an extraction method for the image feature information extraction unit 1306 illustrated in FIG. 1, and the graphic feature information extraction method is an extraction method for the graphic feature information extraction unit 1307 illustrated in FIG. 1.

In step S44, the CPU 1034 extracts the feature information of the objected image data using the feature information extraction method selected in step S43. In step S45, the CPU 1034 registers, in the document management table 1401, the extracted feature information which is extracted using the selected feature information extraction method together with information that indicates the feature information extraction method that has been used, and the image data corresponding to the document to be registered, and then the process ends.

FIG. 5 is a flowchart illustrating an example of a second data processing procedure of the image processing apparatus according to the present exemplary embodiment. In FIG. 5, the processing for selecting the feature information extraction method performed in step S43 in FIG. 4 is taken as an example of the second data processing. Each of steps S51-S56 is realized by the CPU 1034 that reads out a control program stored in the ROM 1300, loads it to the RAM 1039, and executes it.

When the selection processing of the feature information extraction method is started in step S43 in FIG. 4, then in step S51, the CPU 1034 classifies each object that has undergone the block analysis performed by the block analysis unit 1309 according to its attribute (character, image, or graphic). The CPU 1034 calculates a total number of bytes of the bitmap data of each object that has been classified according to the attribute.

In step S52, the CPU 1034 compares the total number of bytes of the object having the character attribute and the total number of bytes of the object having other attributes, and determines whether the object having the character attribute has the largest total number of bytes.

If the CPU 1034 determines that the total number of bytes of the object having the character attribute is the largest (YES in step S52), then in step S53, the CPU 1034 selects the character code feature information extraction method as the feature information extraction method to be used, and then the process ends. The character code feature information extraction unit 1305 is selected as the feature information extraction unit.

In step S52, if the CPU 1034 determines that the total number of bytes of the object including the character attribute is not the largest (NO in step S52), then the process proceeds to step S54. Instep S54, the CPU 1034 compares the total number of bytes of the object including the image attribute and the total number of bytes of the object including the graphic attribute, and determines whether the object including the image attribute has a larger total number of bytes.

In step S54, if the CPU 1034 determines that the total number of bytes of the object having the image attribute is larger than that of the object having the graphic attribute (YES in step S54), then in step S55, the CPU 1034 selects the image feature information extraction method as the feature information extraction method to be used, and then the process ends. The image feature information extraction unit 1306 is selected as the feature information extraction unit.

In step S54, if the CPU 1034 determines that the total number of bytes of the object including the image attribute is not larger than that of the object having the graphic attribute (NO in step S54), then in step S56, the CPU 1034 selects the graphic feature information extraction method as the feature information extraction method to be used, and then the process ends. The graphic feature information extraction unit 1307 is selected as the feature information extraction unit.

As described above, a feature information extraction method that corresponds to an attribute (character, image, or graphic) whose object has the largest total number of bytes is selected based on the calculation performed by the CPU 1034.

The character code feature information extraction method is used in extracting feature information by converting the character in the image data obtained by the block analysis unit 1309 performing the block analysis into a character code in character recognition processing, and then extracting the feature information based on the obtained character code.

The image feature information extraction method is used in extracting feature information by taking hue of the image obtained by the block analysis along the X-axis and then extracting the feature information.

The graphic feature information method is used in extracting feature information by vectorizing a line segment taken from graphic information obtained by the block analysis and then extracting the feature information.

Document registration processing will now be described. This processing is performed when image data in PDL format which is input by an outside device by the user, is registered in the external memory 1043.

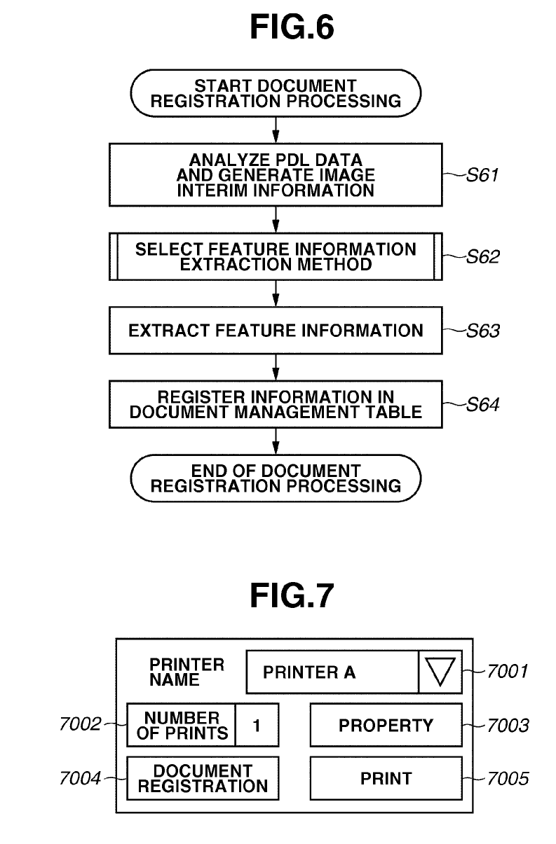

FIG. 6 is a flowchart illustrating an example of a third data processing procedure of the image processing apparatus according to the present exemplary embodiment. In FIG. 6, registration processing of image data in PDL format in the external memory 1043 is taken as an example of the third data processing. Each of steps S61-S64 is realized by the CPU 1034 that reads out a control program stored in the ROM 1300, loads it to the RAM 1039, and executes it.

In registering image data in PDL format (PDL data), the MFP 1000 receives the PDL data from a printer driver installed in the PC 1501 or 1502 to which the MFP 1000 is connected via the network 2000 and registers the data.

FIG. 7 illustrates an example of a user interface displayed on a display device of the information processing apparatus according to the present exemplary embodiment. In FIG. 7, a user interface which is used when the printer driver installed in the PC 1501 or 1502 registers the document is taken as an example of the UI. Compressed or encrypted PDL data can also be applied to the present invention.

In FIG. 7, a spin box 7001 is used in selecting a printer name. The user operates a pointing device or the like in selecting the printer name. A setting box 7002 used for setting a number of sheets to be printed, a property button 7003, a document registration button 7004, and a print button 7005 are also displayed on the display device.

According to the present exemplary embodiment, a “printer A” is the printer name registered in the MFP 1000 having the document registration function.

If the user operates the pointing device and selects the document registration button 7004, the objected image data is sent to the MFP 1000 in PDL format by the printer driver, and then the document registration processing illustrated in FIG. 6 is started.

In step S61, when the CPU 1034 receives the PDL data from the PC 1501 or 1502, the CPU 1034 instructs the PDL data interpretation unit 1302 to interpret the received PDL data and also instruct the image interim information generation unit 1303 to generate image interim information.

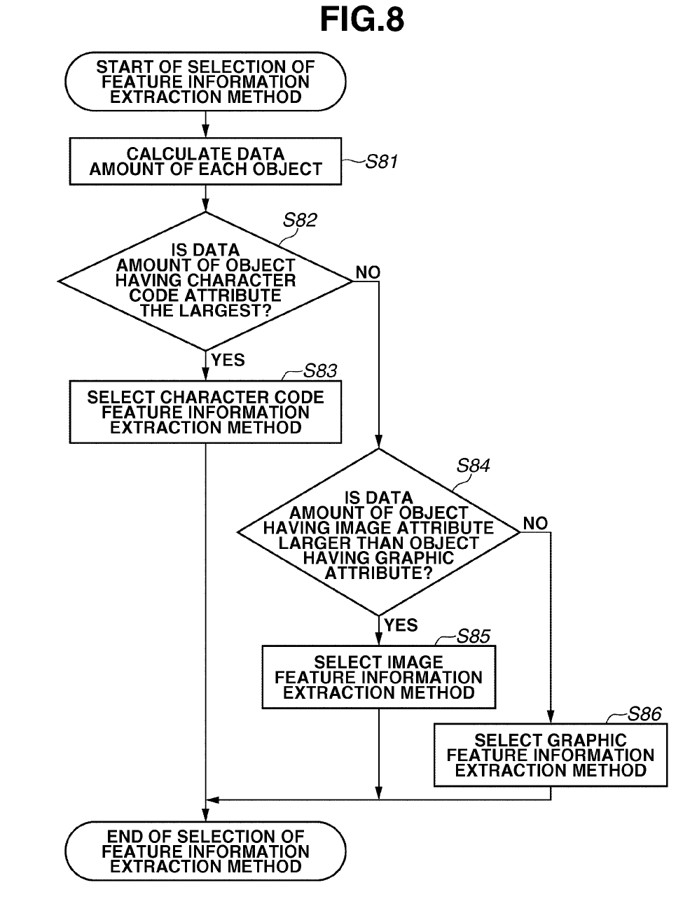

In step S62, the CPU 1034 selects one extraction method among three feature information extraction methods, i.e., the character code feature information extraction method, the image feature information extraction method, and the graphic feature information extraction method. Details of the feature information extraction processing will be described below with reference to FIG. 8.

In step S63, the CPU 1034 extracts feature information using the selected feature information extraction method. In step S64, the CPU 1034 instructs the registered document management unit 1312 to register the extracted feature information, information that indicates the feature information extraction method that has been used, and image data in the document management table 1401, and then the process ends.

FIG. 8 is a flowchart illustrating an example of a fourth data processing procedure of the image processing apparatus according to the present invention. In FIG. 8, the feature information extraction method selection unit 1310 performs the processing for selecting one extraction method among three feature information extraction methods, i.e., the character code feature information extraction method, the image feature information extraction method, and the graphic feature information extraction method. Each of steps S81-S86 is realized by the CPU 1034 that reads out a control program stored in the ROM 1300, loads it to the RAM 1039, and executes it.

When the selection processing of the feature information extraction method is started, in step S81, the CPU 1034 calculates a data amount of the objects having character attribute, image attribute, and graphic attribute, each of which is converted by the image interim information generation unit 1303 into image interim information.

In calculating the data amount of each object, the CPU 1034 calculates the data amount of each object at the time the image interim information is generated, stores the result in the RAM 1039 as data amount information about the object, and calculates the data amount of each object having the character, image, or graphic attribute based on a sum of the data.

In step S82, the CPU 1034 determines whether the data amount of the object having the character attribute is the largest. If the CPU 1034 determines that the data amount of the object having the character attribute is the largest (YES in step S82), then the process proceeds to step S83. In step S83, the CPU 1034 selects the character code feature information extraction method as the feature information extraction method for the PDL data that is input, and then the process ends.

In step S82, if the CPU 1034 determines that the data amount of the object having the character attribute is not the largest (NO in step S82), then the process proceeds to step S84. In step S84, the CPU 1034, determines whether the data amount of the object having the image attribute is larger than that of the object having the graphic attribute. If the CPU 1034 determines that the data amount of the object having the image attribute is larger than that of the object having the graphic attribute (YES in step S84), then the process proceeds to step S85. In step S85, the CPU 1034 selects the image feature information extraction method as the feature information extraction method for the input PDL data, and then the process ends.

In step S84, if the CPU 1034 determines that the data amount of the object having the image attribute is not larger than that of the object having the graphic attribute (NO in step S84), then the process proceeds to step S86. In step S86, the CPU 1034 selects the graphic feature information extraction method as the feature information extraction method for the input PDL data, and then the process ends.

The CPU 1034 selects the feature information extraction method that corresponds to the attribute of an object having the largest data amount.

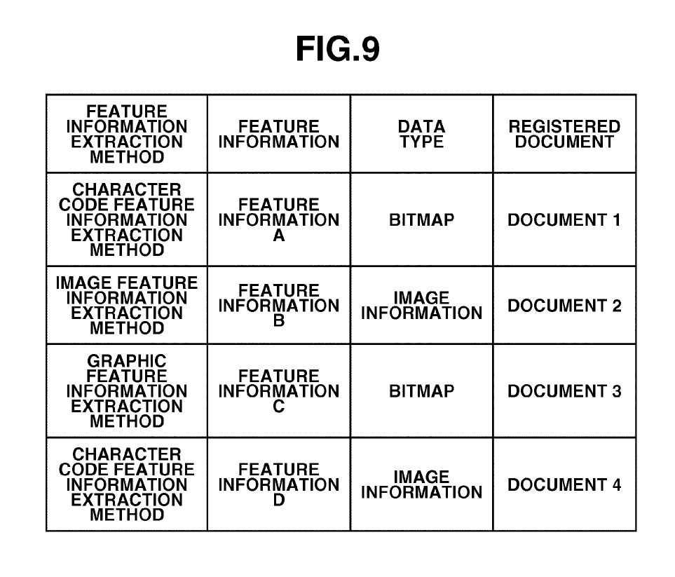

As illustrated in FIG. 9, the document management table 1401 which is managed by the registered document management unit 1312 includes the feature information extraction method used in extracting the feature information, the extracted feature information, the data type, and the registered document.

For example, if bitmap data in a character area of a copy document contains the largest number of bytes, then the feature information A will be extracted using the character code feature information extraction method as illustrated in the first line of FIG. 9, and the data of the document 1 will be registered in the form of bitmap data.

If image data in PDL format is registered, and the data amount of the image area is the largest, then the feature information B will be extracted using the image feature information extraction method as illustrated in the second line, and the data of the document 2 will be registered in the form of image interim information.

When the document registration processing is completed, the CPU1034 converts the information that indicates the selected feature information extraction method and the extracted feature information into a two-dimensional barcode. Then, the converted two-dimensional barcode is added to a predetermined position on a first page of a copy or a first page specified by PDL data, and only the first page will be printed. The predetermined position can be specified automatically or by the user.

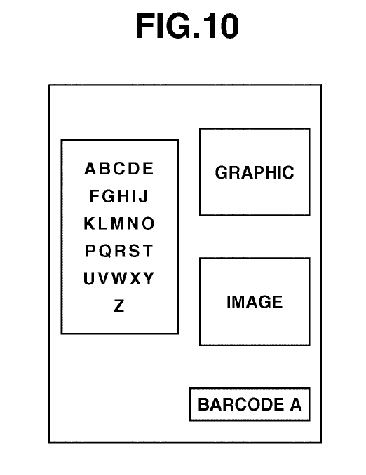

For example, if the number of bytes of the bitmap data of the character area is the largest, and if the feature information A is extracted as the feature information, then, as illustrated in FIG. 10, image data of a two-dimensional barcode A will be added to the objected image data. The two-dimensional barcode A includes information that indicates character code feature information extraction method as the identification information of the feature information extraction method and feature information A as the feature information.

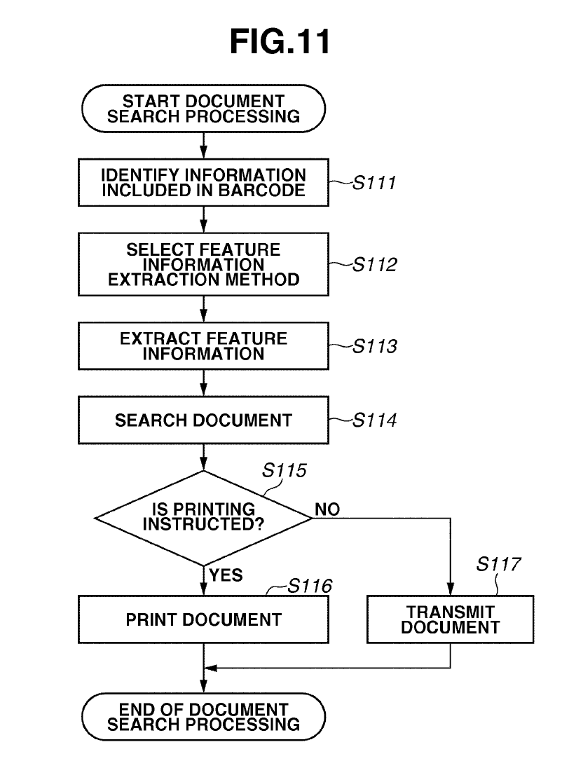

FIG. 11 is a flowchart illustrating an example of a fifth data processing procedure of the image processing apparatus according to the present exemplary embodiment. In FIG. 11, document search processing is taken as an example of the fifth data processing. Each of steps S111-S117 is realized by the CPU 1034 that reads out a control program stored in the ROM 1300, loads it to the RAM 1039, and executes it.

If the user presses the document management button 2009 on the operation panel unit 1041 of the MFP 1000,under control of the CPU 1034, a screen for selecting the document registration button 3001 and the document search button 3002 is displayed on the touch panel.

If the user presses the document search button 3002 on the touch panel, the document search processing is started by the CPU 1034.

In step S111, the scanner unit 1200 scans an image printed with the printer unit 1100. The image is printed on a print product and includes the two-dimensional barcode A printed at a predetermined position. The CPU 1034 identifies the information included in the two-dimensional barcode A.

In step S112, the CPU 1034 determines the feature information extraction method which has been used in the registration of the image data by analyzing the two-dimensional barcode A. The CPU 1034 executes a second selection processing which is performed so as to select the determined feature information extraction method as the feature information extraction method to be used in extracting the feature information of the image data to be searched.

In step S113, the CPU 1034 extracts the feature information of the image data to be searched using the selected feature information extraction method. In step S114, the CPU 1034 searches for a document that matches the feature information by referring to the document management table 1401 stored in the external memory 1043 illustrated in FIG. 1 based on the extracted feature information. In step S115, the CPU 1034 determines whether the user has instructed printing or transmission of the searched document via the operation panel unit 1041.

If the user has instructed printing (YES in step S1 15), then the process proceeds to step S116. In step S116, the searched document registered in the external memory 1043 is transmitted to the printer unit 1100 and printed. Then the process ends.

If the registered image of the document is bitmap data, the CPU 1034 transmits the bitmap data to the printer unit 1100 via the bitmap image transfer unit 1103 and the engine I/F unit 1102 so that printing can be performed.

If the registered image of the document is image interim information, the CPU 1034 converts the image interim information into a bitmap image by the bitmap image conversion unit 1304. Then, the CPU 1034 transmits the bitmap image to the printer unit 1100 via the bitmap image transfer unit 1103 and the engine I/F unit 1102 so that printing can be performed.

In step S115, if the user has issued an instruction to transmit the document (NO in step S115), then the process proceeds to step S117. In step S117, the user is asked to input an address of the destination using the touch panel. If the registered image is bitmap data, the CPU 1034 transmits the bitmap data to the address input by the user via the input/output buffer 1033 and the input/output unit 1032. The CPU 1034 can transmit the bitmap data after compressing or encrypting the data.

If the registered image is image interim information, the CPU 1034 converts the image interim information into bitmap image data by the bitmap image conversion unit 1304. The CPU 1034 transmits the converted bitmap data to the address input by the user via the input/output buffer 1033 and the input/output unit 1032.

According to the above description, the information that indicates the feature information extraction method that has been used in extracting the feature information is converted into a barcode, added to the first page of the image data, and output.

However, instead of using a barcode illustrated in FIG. 10, a radio frequency identification (RFID) tag including the information in FIG. 9 can be embedded on print paper, or a digital watermark including the information in FIG. 9 can be embedded on the document.

As described above, since one feature information extraction method is selected among a plurality of feature information extraction methods, extracting feature information using a plurality of feature information extraction methods becomes unnecessary. This helps improve processing speed of document registration and document searching.

Additionally, since only one type of feature information is registered, the amount of feature information stored in the external memory 1043 can be reduced. In this way, memory resources of the external memory 1043 can be used efficiently.

According to the first exemplary embodiment, one feature information extraction method is automatically selected among a plurality of feature information extraction methods in registering a document. However, the feature information extraction method can be manually selected by the user.

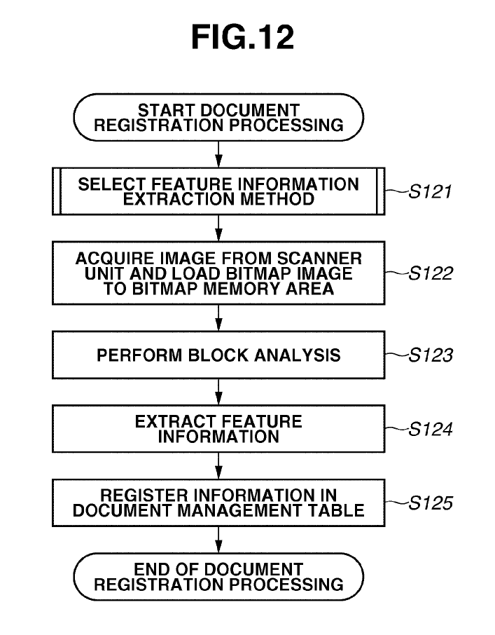

FIG. 12 is a flowchart illustrating an example of a sixth data processing procedure of the image processing apparatus according to the present exemplary embodiment. In FIG. 12, document registration processing by which a document is copied and registered according to an instruction given by a user is taken as an example of the sixth data processing. Each of steps S121-S125 is realized by the CPU 1034 that reads out a control program stored in the ROM 1300, loads it to the RAM 1039, and executes it.

If the user operates the operation panel unit 1041 and presses the document management button 2009 illustrated in FIG. 2, under control of the CPU 1034, the display screen is changed to the screen that displays the document registration button 3001 and the document search button 3002 illustrated in FIG. 3.

If the user selects the document registration button 3001, then the document registration processing is started.

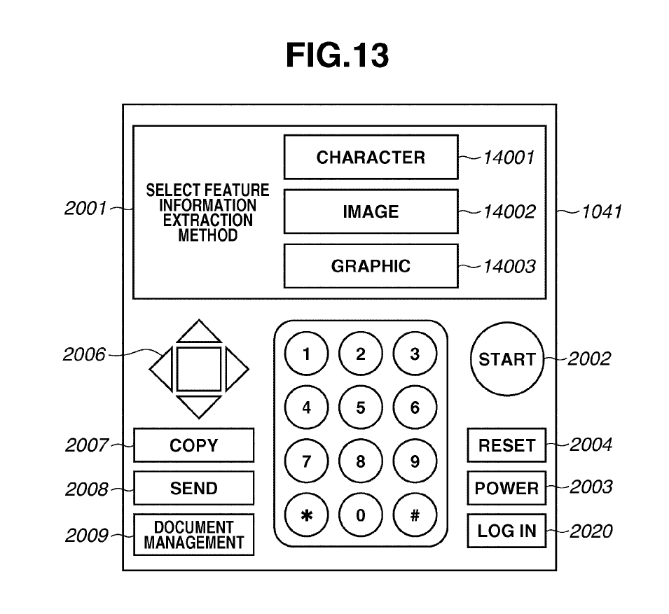

The user interface which will be used for selecting the feature information extraction method is displayed on the touch panel as illustrated in FIG. 13. In step S121, the CPU 1034 instructs the user to select one feature information extraction method among three feature information extraction methods displayed on the touch panel.

FIG. 13 illustrates an example of the user interface displayed on the touch panel illustrated in FIG. 2. The user interface illustrated in FIG. 13 is a screen used by the user for manually selecting a feature information extraction method.

If a character button 14001 displayed on the touch panel is selected by the user, the character code feature information extraction method will be selected as the feature information extraction method.

If an image button 14002 displayed on the touch panel is selected by the user, the image feature information extraction method will be selected as the feature information extraction method.

If a graphic button 14003 displayed on the touch panel is selected by the user, the graphic feature information extraction method will be selected as the feature information extraction method.

After the feature information extraction method is selected, if the user presses the start key 2002, the process proceeds to step S122. In step S122, the CPU 1034 instructs the scanner unit 1200 to scan the image included in the document and generate image data. The CPU 1034 receives the generated image data from the scanner unit 1200 via the scanner I/F unit 1202 and the bitmap image receiving unit 1203, and supplies the data to the bitmap memory area 1500.

In step S123, the CPU 1034 instructs the block analysis unit 1309 to perform the block analysis of the bitmap data. In step S124, the CPU 1034 extracts the feature information using the selected feature information extraction method.

In step S125, the CPU 1034 instructs the registered document management unit 1312 to register the feature information extracted in step S124 and all the bitmap data of the copy document in the document management table 1401, and then the process ends.

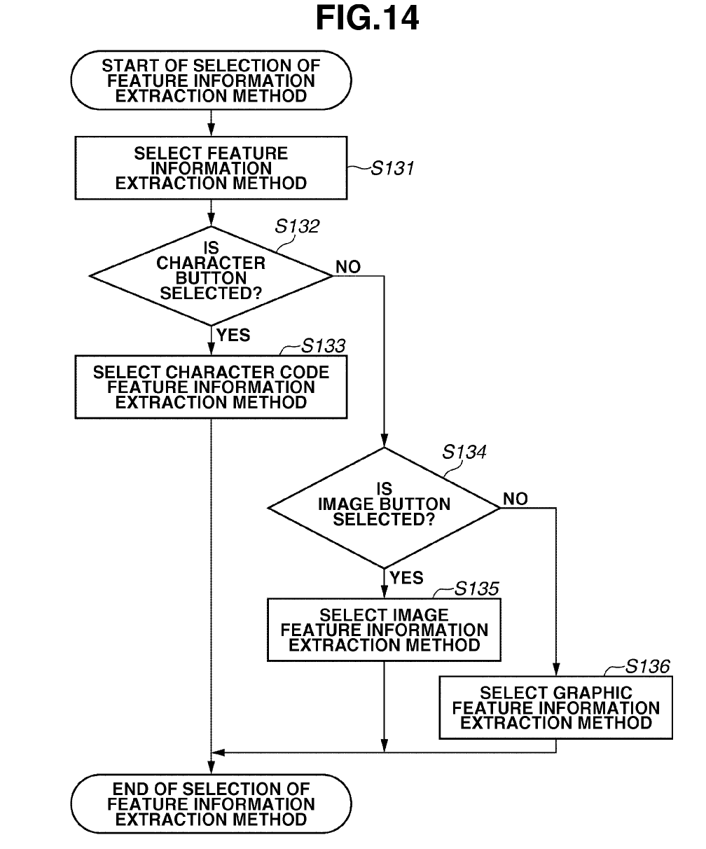

FIG. 14 is a flowchart illustrating an example of a seventh data processing procedure of the image processing apparatus according to the present exemplary embodiment. In FIG. 14, selection processing of the feature information extraction method in step S121 in FIG. 12 is taken as an example of the seventh data processing. Each of steps S131-S136 is realized by the CPU 1034 that reads out a control program stored in the ROM 1300, loads it to the RAM 1039, and executes it.

In step S121 in FIG. 12, the user starts the selection processing of the feature information extraction method using the user interface displayed on the touch panel of the operation panel unit 1041 illustrated in FIG. 13.

In step S131, the user selects a feature information extraction method by selecting one button among the character button 14001, the image button 14002, and the graphic button 14003. In step S132, the CPU 1034 determines whether the user has selected the character code feature information extraction method by pressing the character button 14001.

If the CPU 1034 determines that the user has pressed the character button 14001 (YES in step S132), then the process proceeds to step S133. In step S133, the CPU 1034 selects the character code feature information extraction method, and then the process ends.

In step S132, if the CPU 1034 determines that the user has not pressed the character button 14001 (NO in step S132), then the process proceeds to step S134. In step S134, the CPU 1034 determines whether the user has selected the image feature information extraction method using the image button 14002.

If the CPU 1034 determines that the user has pressed the image button 14002 (YES in step S134), then the process proceeds to step S135. In step S135, the CPU 1034 selects the image feature information extraction method, and then the process ends.

If the CPU 1034 determines that the user has not pressed the image button 14002 (NO in step S134), then the process proceeds to step S136. In step S136, the CPU 1034 determines that the user has selected the graphic button 14003, and selects the graphic feature information extraction method. Then the process ends.

Document registration processing which is performed when a document is registered in PDL format according to an instruction by the user will now be described.

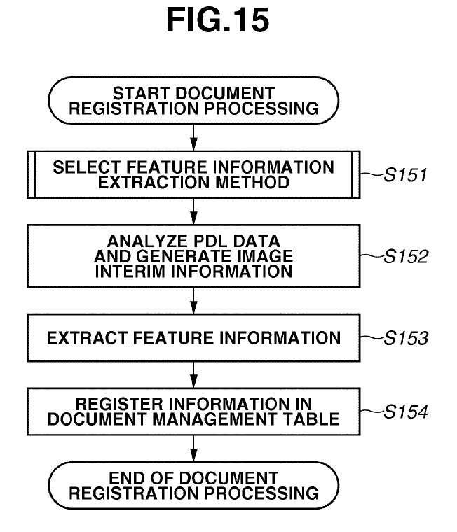

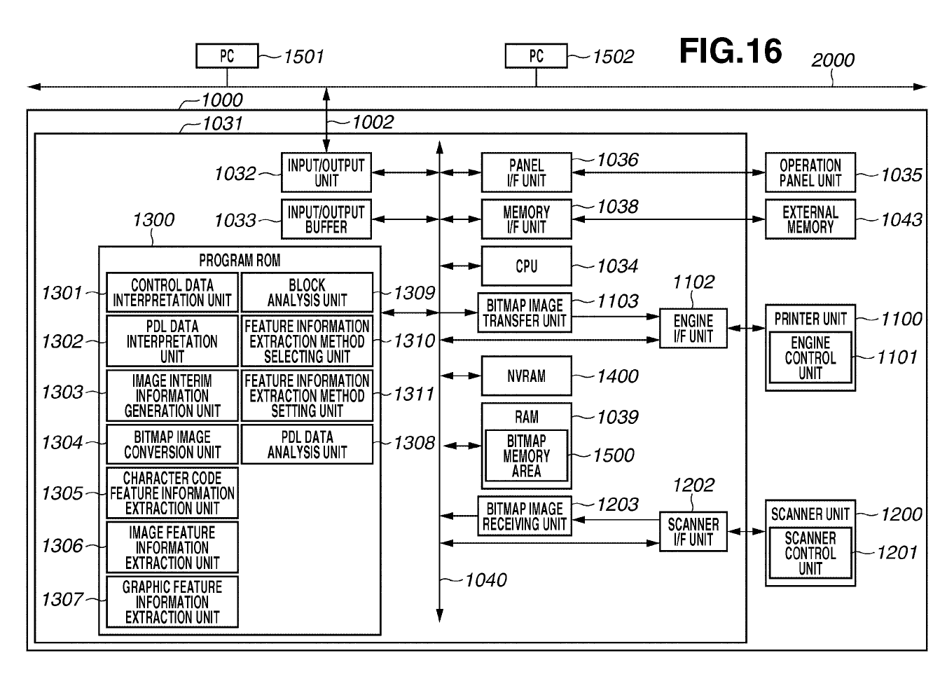

FIG. 15 is a flowchart illustrating an example of an eighth data processing procedure of the image processing apparatus according to the present invention. In FIG. 15, processing for registering a document in PDL format is taken as an example of the eighth data processing. Each of steps S151-S154 is realized by the CPU 1034 that reads out a control program stored in the ROM 1300, loads it to the RAM 1039, and executes it.

If the user operates the operation panel unit 1041 and presses the document management button 2009 illustrated in FIG. 2,under control of the CPU 1034, the display screen is changed to the screen that displays the document registration button 3001 and the document search button 3002 illustrated in FIG. 3. Then the user selects either the document registration button 3001 or the document search button 3002.

If the document registration button 3001 is selected, the document registration processing is started.

Under control of the CPU 1034, the screen used for selecting the feature information extraction method is displayed on the touch panel as illustrated in FIG. 13. In step S151, the user selects any one button among a character button 140001, an image button 140002, and a graphic button 140003 displayed on the touch panel to select a feature information extraction method. The selection method of the feature information extraction method is similar to the method described referring to FIG. 14.

When the user selects the feature information extraction method using the touch panel, the CPU 1034 waits until PDL data is sent from the PC 1501 or 1502 via the network 2000.

In step S152, if the CPU 1034 receives the PDL data from the PC 1501 or 1502, the CPU 1034 instructs the PDL data interpretation unit 1302 to interpret the received PDL data and also instructs the image interim information generation unit 1303 to generate image interim information.

In step S153, the CPU 1034 extracts feature information from the generated image interim information using the feature information extraction method selected by the user in step S151.

According to the feature information extraction method selected by the user, the CPU 1034 instructs one extraction unit selected from the character code feature information extraction unit 1305, the image feature information extraction unit 1306, and the graphic feature information extraction unit 1307 stored in the program ROM 1300 to extract the corresponding feature information.

In step S154, the CPU 1034 instructs the registered document management unit 1312 to register the feature information extracted in step S153 and the image interim information of the document in the document management table 1401, and then the process ends.

When the document registration processing is completed, the CPU1034 converts the information that indicates the selected feature information extraction method and the extracted feature information into a two-dimensional barcode similar to the first exemplary embodiment. The two-dimensional barcode is added to a predetermined position on a first page of a copy or a first page specified by PDL data, and only the first page will be printed.

Since the feature information extraction method can be selected by the user, the feature information can be extracted without the block analysis processing, thus the selection processing of the feature information extraction method can be simplified, and the processing time at the time of document registration can be reduced.

Whether the feature information extraction method is to be automatically selected or to be selected by the user can be determined by the user. Processing which the user selected can be set on a priority basis.

Whether the feature information extraction method is to be automatically selected or to be selected by the user can be registered in the NVRAM 1400 as a selection mode. In this case, in making the initial settings when the power of the apparatus is turned on, the feature information extraction method that is to be executed by the CPU 1034 can be changed.

According to the first and the second exemplary embodiments, registration, search, and management of a document is performed by one digital multifunction peripheral. However, a system including a server that manages feature information and documents can also be established according to the present invention.

FIG. 16 is a block diagram illustrating a configuration of an image processing apparatus applicable to a document search system according to a third exemplary embodiment of the present invention. In FIG. 16, a digital MFP including a scanner unit and a printer unit is used as the image processing apparatus. Components illustrated in FIG. 16, which are similar to those illustrated in FIG. 1, are given the same reference numerals. Further, while the system configuration illustrated in FIG. 16 is similar to the configuration described in the first exemplary embodiment, since the management server manages the document in the present exemplary embodiment, the registered document management unit 1312 and the registered document search unit 1313 are not included in the digital MFP illustrated in FIG. 16. Further, the document management table 1401 is not included in the external memory 1043.

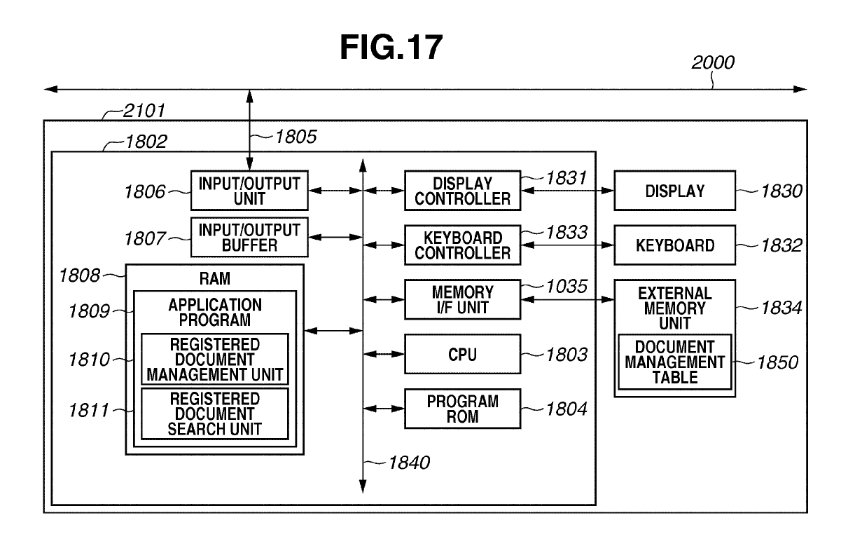

FIG. 17 is a block diagram illustrating a configuration of a server applicable to the document search system according to the present exemplary embodiment.

In FIG. 17, a management server 2101 is communicatably connected to a digital multifunction peripheral 1000 illustrated in FIG. 16 via the network 2000.

A control unit 1802 is configured to control the operation of the management server 2101. The control unit 1802 includes a CPU 1803 that controls the whole operation of the computer.

A program that describes the operation of the CPU 1803 is stored in a program ROM 1804. An input/output unit 1806 transmits a control code for controlling PC 1501 or 1502 and the digital multifunction peripheral 1000 and also data via a communication line 1805 connected to the network 2000.

An input/output buffer 1807 is used for transmitting various control codes and feature information input via the network 2000 and is also used for transmitting various data.

A RAM 1808 is used as a work memory for performing interpretation of the above-described control codes and data, calculation necessary in printing, or processing of print data. An application program (AP program) 1809 which is application software running on the management server 2101 or a program describing operation of a driver is loaded into the RAM 1808.

A registered document management unit 1810 and a registered document search unit 1811 are included in the AP program 1809. The registered document management unit 1810 manages feature information extracted from the document at the time of document registration, and information indicating the feature information extraction method. The registered document search unit 1811 searches for a document based on feature information about a document to be searched at the time of document search.

A display controller 1831 controls a display 1830 that displays an image processed by the management server 2101.

A keyboard controller 1833 controls a keyboard 1832 that receives a command input by the user.

A memory I/F unit 1835 controls an external memory 1834. The external memory 1834 is a non-volatile memory, such as a hard disk, used for storing print data or various information on the host computer. Further, a document management table 1850 is included in the external memory 1834. The document management table 1850 contains information such as a document to be registered, electronic data of the document to be registered, extracted feature information, and information indicating the feature information extraction method.

A system bus 1840 connects each device in the control unit to the CPU 1803.

Document registration processing performed by the management server 2101 will now be described.

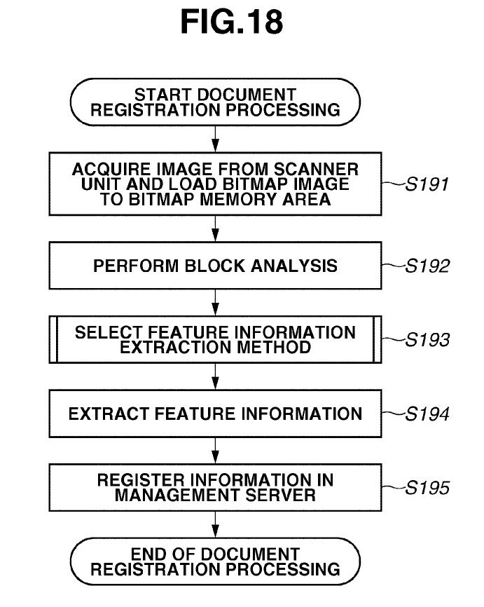

FIG. 18 is a flowchart illustrating an example of a ninth data processing procedure of the image processing apparatus according to the present exemplary embodiment. In FIG. 18, a copied document is registered according to the instruction given by the user while the management server 2101 is being used. Each of steps S191-S195 is realized by the CPU 1034 that reads out a control program stored in the ROM 1300, loads it to the RAM 1039, and executes it.

Since steps S191-S194 are similar to steps S41-S44 in FIG. 4, their description will be omitted.

In step S195, the CPU 1034 transmits the feature information, the information indicating the feature information extraction method, and the document in electronic format to the management server 2101 via the input/output unit 1032, and then the document registration processing ends.

Document registration processing at the time a document is registered as PDL data according to an instruction given by the user will be described.

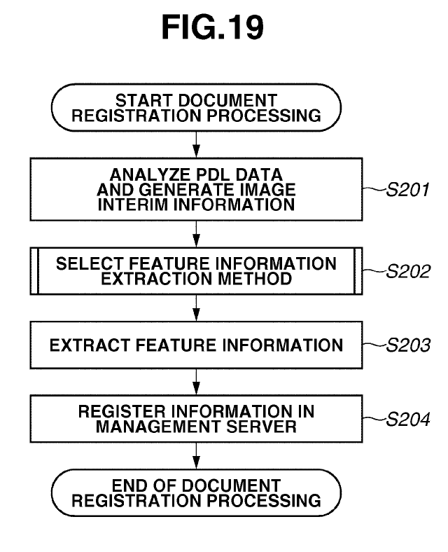

FIG. 19 is a flowchart illustrating an example of a tenth data processing procedure of the image processing apparatus according to the present embodiment. In FIG. 19, a copied document is registered by the user while the management server 2101 is being used. Each of steps S201-S204 is realized by the CPU 1034 that reads out a control program stored in the ROM 1300, loads it to the RAM 1039, and executes it.

In step S204, the CPU 1034 transmits the feature information, the information indicating the feature information extraction method, and the document in electronic data to the management server 2101 via the input/output unit 1032, and then the document registration processing ends.

When the management server 2101 receives the feature information, the information indicating the feature information extraction method, and the computerized document from the digital multifunction peripheral 1000, the CPU 1803 instructs the registered document management unit 1810 to perform the document registration processing by registering the data in the document management table 1850.

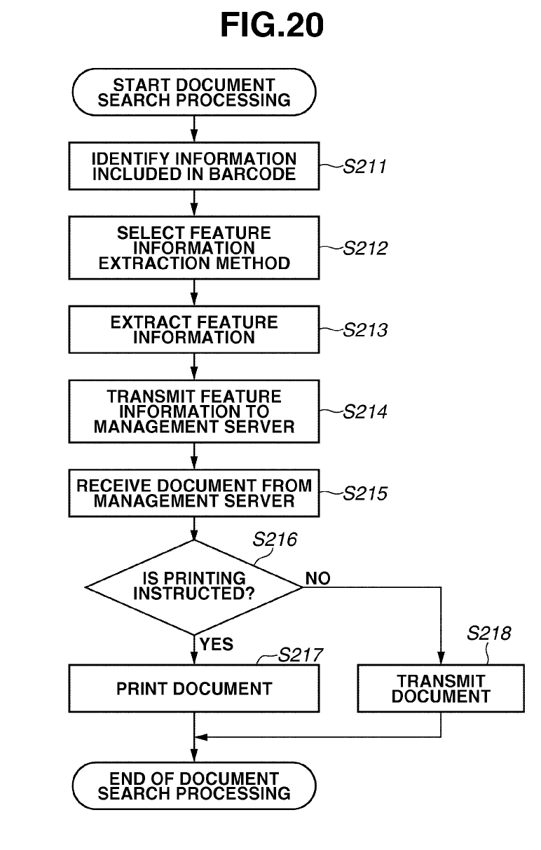

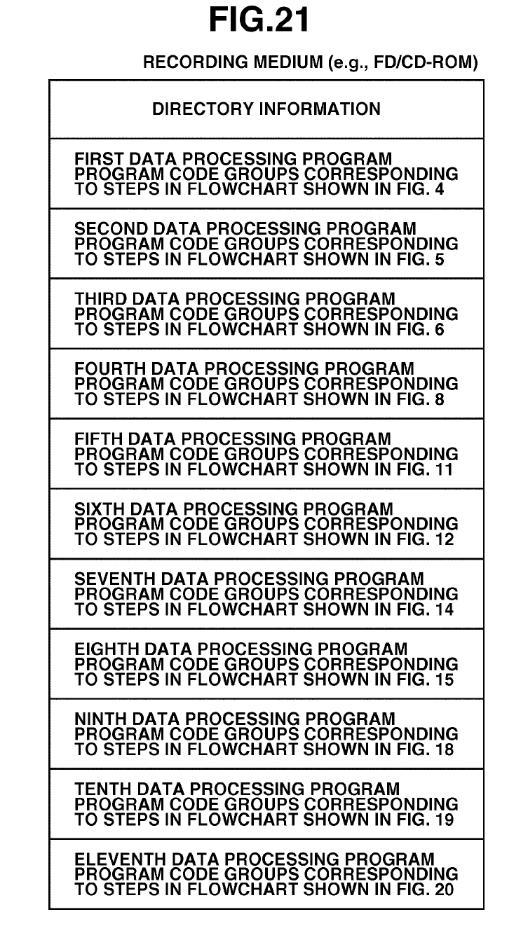

FIG. 20 is a flowchart illustrating an example of an eleventh data processing procedure of the image processing apparatus according to the present exemplary embodiment. In FIG. 20, a document is searched according to the instruction given by the user while the management server 2101 is being used. The steps S211-218 are basically similar to those illustrated in FIG. 11 except for steps S214 and S215.

In the processing according to the present exemplary embodiment, after the feature information is extracted in step S213, the CPU 1034 sends the feature information obtained via the input/output unit 1032 to the management server 2101 in step S214.

The CPU 1803 of the management server 2101 instructs the registered document search unit 1811 to search for a document that matches the feature information extraction method and the feature information from the document management table 1850, and the searched document is sent to the digital multifunction peripheral 1000 via the input/output unit 1806.

In step S215, the digital multifunction peripheral 1000 receives the document that matches the feature information from the management server 2101. Then, in steps S216-S218, processes similar to those performed in steps S115-S117 illustrated in FIG. 11 are executed, i.e., printing or transmission processing is performed, and then the process ends.

According to the present exemplary embodiment, a document can be searched from each digital multifunction peripheral by establishing a system that includes a management server used for managing feature information and documents. This system eliminates the need for preparing a document management table for each apparatus. Accordingly, overlapping management of registered documents can be avoided and uniform management of the registered documents becomes possible.

While the bitmap data or the image interim information is used in the registration of the image according to the first through the third exemplary embodiments, the data and information can be compressed before it is stored in order to reduce the volume of the registered image.

According to the above-described embodiments, the feature information extraction method is based on a character code, an image histogram, or a vectorized graphic. However, a different feature information extraction method can be added or can be used in place of the current feature information extraction method.

Further, by selecting one feature information extraction method among a plurality of feature information extraction methods, calculation of the feature information can be simplified and a plurality of feature information do not need to be extracted. Thus, the processing speed can be improved.

Additionally, since only one type of feature information is registered, the amount of feature information that needs to be stored can be reduced, and thus data capacity necessary in storing the registered document management unit can be reduced.

Since the feature information extraction method can be selected by the user, the feature information can be extracted without performing the block analysis processing, thus the selection processing of the feature information extraction method can be simplified. Accordingly, the processing time at the time of document registration can be reduced.

By using the document that has been used in the registration of the document for the document search, printing of unnecessary pages for searching can be avoided. By storing only the document used at the time of registration, the original registered document can be searched with ease.

Since a document can be searched from each digital multifunction peripheral by the system that includes a management server used for managing feature information and documents, the need for preparing a document management table for each apparatus can be eliminated. Thus, overlapping management of registered documents can be avoided and uniform management of the registered documents becomes possible.

Referring now to a memory map illustrated in FIG. 21, a configuration of a data processing program which can be read out by an image processing apparatus according to the above-described embodiments will be described.

FIG. 21 is a memory map of a storage medium configured to store various types of data processing programs which can be read out by the image processing apparatus according to the present invention.

Although not illustrated, information for managing a program group stored in the storage medium, for example, version information and author information can be stored in this storage medium. Furthermore, information which depends on the OS on a program readout side, for example, an icon or the like used for identifying a program, can also be stored in the storage medium.

Data which is dependent on various programs is stored in a directory. Furthermore, programs for installing various programs in a computer and a decompression program which is used when a program to be installed is compressed, are stored in the directory.

Also, each function realized by an execution of a process of each flowchart illustrated in FIGS. 4, 5, 6, 8, 11, 12, 14, 15, 18, 19, and 20 according to the above-described embodiments can also be realized by a host computer using a program installed from an outside device. The present invention can also be applied when an information group including a program is provided to an output apparatus from a storage medium such as a CD-ROM, a flash memory, a flexible disk, or an outside storage medium via a network.

As described above, a storage medium storing a software program code which realizes a function of the above-described embodiments is supplied to the peripheral apparatus control system or the information processing apparatus, or the peripheral apparatus. Thus, the object of the above-described embodiments can be also achieved when a computer (or a CPU or a MPU) of the peripheral apparatus control system or the information processing apparatus, or the peripheral apparatus reads and executes the program code stored in such a storage medium.

The program code read out from the storage medium realizes the novel functions of the present invention. Thus, the storage medium which stores the program code constitutes the present invention.

Thus, a form of the program can be in any form, such as object code, a program executed by an interpreter, or script data supplied to an OS so long as the computer-executable program has a function of a program.

As a storage medium which provides the program code, a floppy disk, a hard disk, an optical disk, a magneto-optical disk, a CD-ROM, a CD-R, a magnetic tape, a non-volatile memory card, a ROM, or a DVD, etc. may be used.

In this case, the program code itself read out from the storage medium realizes the functions described in the above-described embodiments. Thus, the storage medium which stores the program code constitutes the present invention.

The program can be supplied to a user by connecting to an Internet website using a browser of a client computer and downloading the computer-executable program of the present invention or a compressed file including an automated installation function into a recording medium, such as a hard disk. Further, the program code that constitutes the program of the exemplary embodiments of the present invention can be divided into a plurality of files and each file can be downloaded from different Internet websites. In other words, a World Wide Web (WWW) server or a file transfer protocol (ftp) server which allows a plurality of users to download a program file to realize the functions of the present invention also constitutes the present invention.

Furthermore, the program of the present invention can be encrypted, recorded on a recording medium, such as a CD-ROM, and delivered to users. In this case, a user who satisfies a predetermined condition is allowed to download decryption key information from an Internet website via the Internet, to decrypt the encrypted program using the decryption key information, and installs the decrypted program on the computer.

A function of the above-described embodiments is realized not only when the computer executes the program code. For example, an OS or the like, which runs on a computer, can execute a part or whole of the actual processing based on an instruction of the program code so that a function of the above-described embodiments can be achieved.

Furthermore, the program code read out from the recording medium is written in a memory in a function expanding board inserted in a computer or a function expanding unit connected to a computer and a CPU provided in the function expanding board or the function expanding unit performs the whole or a part of the actual processing based on an instruction from the program code to realize the functions of the above-described exemplary embodiments.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-120977 filed May 7, 2008, which is hereby incorporated by reference herein in its entirety.

What is claimed is:

1. An image processing apparatus comprising:
a storage unit configured to store objected image data;
a first selection unit configured to select any one extraction method among a plurality of extraction methods;
an extraction unit configured to extract feature information indicating a feature of the objected image data using the extraction method selected by the first selection unit, from the objected image data;
a registration unit configured to register feature information extracted by the extraction unit; and
an output unit configured to output the objected image data with identification information indicating the extraction method selected by the first selection unit.

2. The image processing apparatus according to claim 1, further comprising:
a second selection unit configured to select any one extraction method among the plurality of extraction methods based on the identification information output by the output unit, and
a search unit configured to search for the feature information registered by the registration unit based on feature information indicating feature of image data to be searched that is extracted from the search target image data using the extraction method selected by the second selection unit.

3. The image processing apparatus according to claim 1, wherein the output unit outputs the objected image data after adding image data corresponding to the identification information.

4. The image processing apparatus according to claim 3, wherein the image data corresponding to the identification information is barcode information indicating the identification information.

5. The image processing apparatus according to claim 1, further comprising:
a reading unit configured to read an image included in a document and generate image data corresponding to the image,
wherein the storage unit stores the image data generated by the reading unit as the objected image data.

6. The image processing apparatus according to claim 1, further comprising:
a receiving unit configured to receive image data from an external apparatus connected via a network, wherein the storage unit stores the image data received by the receiving unit as the objected image data.

7. The image processing apparatus according to claim 1, wherein the first selection unit automatically selects the extraction method based on an attribute of an object included in the objected image data.

8. The image processing apparatus according to claim 1, wherein the first selection unit selects the extraction method based on an instruction given by a user.

9. The image processing apparatus according to claim 1, wherein the registration unit registers information indicating the extraction method selected by the first selection unit together with the feature information extracted by the extraction unit.

10. The image processing apparatus according to claim 1, wherein the plurality of extraction methods include at least one among a method for extracting text feature information based on text area in image data, a method for extracting image feature information based on image area in image data, and a method for extracting graphic feature information based on graphic area in image data.

11. An image processing method comprising:
selecting any one extraction method among a plurality of extraction methods;
extracting feature information indicating a feature of objected image data from the objected image data using the selected extraction method;
registering the extracted feature information; and
outputting the objected image data with identification information indicating the selected extraction method.

12. A computer-readable storage medium storing a program for causing a computer to execute the image processing method comprising:
selecting any one extraction method among a plurality of extraction methods;
extracting feature information indicating a feature of objected image data from the objected image data using the selected extraction method;
registering the extracted feature information; and
outputting the objected image data with identification information indicating the selected extraction method.
